(19) United States
(12) Patent Application Publication
(10) Pub. No.: US 2025/0038216 A1
(43) Pub. Date: Jan. 30, 2025

(54) Conductive Material Dispersion, Electrode Slurry and Lithium Secondary Battery

(71) Applicant: SK INNOVATION CO., LTD., SEOUL (KR)

(72) Inventors: Sang Hye Shin, Daejeon (KR); Hyun Ji Jeon, Daejeon (KR); Soo Bean Kim, Daejeon (KR); Hyun Suk Chung, Daejeon (KR)

(21) Appl. No.: 18/616,844

(22) Filed: Mar. 26, 2024

(30) Foreign Application Priority Data
Jul. 26, 2023 (KR) 10-2023-0097717

(51) Int. Cl. H01M 4/62; H01M 4/02; H01M 10/052

(52) U.S. Cl. CPC H01M 4/625; H01M 10/052; H01M 2004/028

(57) ABSTRACT

A conductive material dispersion, an electrode slurry and a lithium secondary battery, where the conductive material dispersion includes a conductive material including carbon nanotubes, a hydrogenated nitrile-based copolymer, a multivalent amine-based compound, and a solvent, the electrode slurry includes the conductive material dispersion, and the lithium secondary battery includes an electrode active material layer formed from the electrode slurry. An amine value of the conductive material dispersion is 5 mgKOH/g to 30 mgKOH/g.

### CROSS-REFERENCE TO RELATED APPLICATION

This application claims priority to Korean Patent Application No. 10-2023-0097717 filed Jul. 26, 2023, the disclosure of which is hereby incorporated by reference in its entirety.

### BACKGROUND OF THE INVENTION

### 1. Field of the Invention

The disclosure of this patent application relates to a conductive material dispersion, an electrode slurry and a lithium secondary battery.

### 2. Description of Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery has been developed and applied as a power source for an eco-friendly vehicle such as an electric vehicle.

Examples of the secondary battery includes, e.g., a lithium secondary battery, a nickel-cadmium battery, a nickel-hydrogen battery, etc. The lithium secondary battery has been actively developed and applied due to high operational voltage and energy density per unit weight, a high charging rate, a compact dimension, etc.

An electrode for the secondary battery electrode may include a conductive material. The conductive material may provide a conductivity between electrode active material particles to reduce a resistance in the electrode. A dot-type (sphere-type) conductive material such as carbon black and a linear-type conductive material such as a carbon nanotube may be used as the conductive material. For example, an electrode slurry may be prepared by mixing the electrode active material particles and the conductive material, and the electrode for a secondary battery may be prepared using the electrode slurry.

However, when the conductive material is mixed in the electrode slurry in a powder state, the conductive material may not be uniformly dispersed in the slurry to deteriorate the conductivity of the electrode. Thus, the conductive material may be mixed with a dispersant and a dispersive medium to prepare a conductive material dispersion, and then the electrode slurry may be prepared using the conductive material dispersion.

### SUMMARY OF THE INVENTION

According to an aspect of the present disclosure, there is provided a conductive material dispersion having improved dispersibility.

According to an aspect of the present disclosure, there is provided an electrode slurry having improved dispersibility.

According to an aspect of the present disclosure, there is provided a lithium secondary battery having improved electrochemical properties.

A conductive material dispersion according to embodiments of the present disclosure includes a conductive material including carbon nanotubes, a hydrogenated nitrile-based copolymer, a multivalent amine-based compound, and a solvent. An amine value of the conductive material dispersion is in a range from 5 mgKOH/g to 30 mgKOH/g.

In some embodiments, a content of the conductive material may be in a range from 3 wt % to 10 wt % based on a total weight of the conductive material dispersion.

In some embodiments, a content of the hydrogenated nitrile-based copolymer may be in a range from 10 parts by weight to 50 parts by weight based on 100 parts by weight of the conductive material.

In some embodiments, a content of the multivalent amine-based compound may be in a range from 5 parts by weight to 50 parts by weight based on 100 parts by weight of the conductive material.

In some embodiments, a weight ratio of the multivalent amine-based compound relative to the hydrogenated nitrile-based copolymer is in a range from 0.5 to 2.

In some embodiments, the hydrogenated nitrile-based copolymer may include a hydrogenated nitrile butadiene rubber.

In some embodiments, the multivalent amine-based compound may have at least two amine groups selected from a primary amine group (NH₂) and a secondary amine group (NH).

In some embodiments, the multivalent amine compound may include at least one of compounds represented by Chemical Formulae 1 to 3.

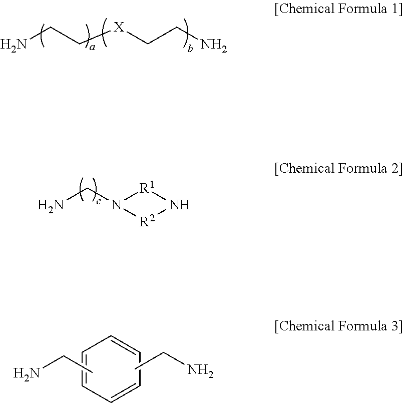

In Chemical Formula 1, X represents —O—, —NH— or —N(CH₂CH₂NH₂)—, 1≤a≤10 and 0≤b≤10. In Chemical Formula 2, R¹ and R² are each independently a C1 to C10 alkylene group, and 1≤c≤3.

In some embodiments, 1≤a≤3 and 0≤b≤4 in Chemical Formula 1.

In some embodiments, the solvent may include a non-aqueous solvent.

In some embodiments, the non-aqueous solvent may include a polar organic solvent.

In some embodiments, a UV absorbance (AU) in a wavelength range of 300 nm to 500 nm may be 0.5 or more when the UV absorbance of the conductive material dispersion is measured under a concentration condition of 10 mg/L to 100 mg/L.

An electrode slurry includes the conductive material dispersion according to the above-described embodiments, an electrode active material and a binder.

In some embodiments, the electrode active material may be a cathode active material.

A lithium secondary battery includes an electrode for a lithium secondary battery including an electrode active material layer formed from the electrode slurry according to the above-described embodiments, and a counter electrode facing the electrode for a lithium secondary battery.

According to embodiments of the present disclosure, a conductive material dispersion includes a hydrogenated nitrile-based copolymer, a multivalent amine-based compound and a solvent, and may have an amine value in a desirable range. Dispersibility and storage stability of the conductive material dispersion may be improved, and the conductive material dispersion may have a low sheet resistance.

According to embodiments of the present disclosure, a lithium secondary battery may include an electrode formed of an electrode slurry including the above-described conductive material dispersion. The lithium secondary battery may have low internal resistance and improved power properties.

The lithium secondary battery of the present disclosure may be widely applied in green technology fields such as an electric vehicle, a battery charging station, a solar power generation, a wind power generation, etc., using a battery. The lithium secondary battery according to the present disclosure may be used for eco-friendly electric vehicles and hybrid vehicles to prevent a climate change by suppressing air pollution and greenhouse gas emission.

### BRIEF DESCRIPTION OF THE DRAWINGS

FIGS. 1 and 2 are a schematic plan view and a schematic cross-sectional view illustrating a secondary battery in accordance with exemplary embodiments.

FIG. 3 is a graph showing an absorbance of a conductive material dispersion prepared in Example 2.

FIG. 4 is a graph showing an absorbance of a conductive material dispersion prepared in Comparative Example 5.

### DESCRIPTION OF THE INVENTION

According to embodiments of the present disclosure, a conductive dispersion including a conductive material is provided. According to embodiments of the present disclosure, an electrode slurry including the conductive material dispersion is provided.

According to embodiments of the present disclosure, a lithium secondary battery including an electrode formed using the electrode slurry is provided.

Hereinafter, detailed descriptions of the present disclosure will be described in detail with reference to exemplary embodiments.

When there is an isomer of a compound represented by a chemical formula used in this disclosure, the compound represented by the formula refer to a representative formula including the isomer.

The term “X-based compound” as used in the present disclosure may a specific compound X or a derivative thereof, or a compound containing an element X or a functional group X. For example, the amine-based compound may refer to a compound containing an amine group or a derivative of the compound.

According to embodiments of the present disclosure, the conductive material dispersion may include a conductive material and a dispersant.

In example embodiments, the conductive material may include a carbon-based conductive material. In an embodiment, the conductive material may be included in the conductive material dispersion in a powder of powder.

In an embodiment, the conductive material may contain a fibrous carbon-based conductive material, and may contain, e.g., a carbon nanotube (CNT).

The carbon nanotube may refer to a polymer carbon allotrope in which carbon atoms form a sp2 bonding structure to be connected with each other in a hexagonal honeycomb shape. The carbon nanotube may have a cylindrical shape having a diameter of a nanometer unit.

The carbon nanotube may have high electrical conductivity and mechanical strength.

Thus, the carbon nanotubes may be located between electrode active materials, and micropores between the electrode active materials may be prevented from being clogged even when pressing and molding processes are performed for a formation of an electrode. Accordingly, an electrolyte may easily penetrate into the electrode, and an internal resistance of the electrode may be lowered.

In some embodiments, the carbon nanotube may include a single-walled carbon nanotube (SWCNT), a double-walled carbon nanotube (DWCNT) and/or a multi-walled carbon nanotube (MWCNT).

In an embodiment, an average length of the carbon nanotube may be in a range from about 0.1 μm to about 100 μm, from about 0.1 μm to about 50 μm, or from about 1 μm to about 10 μm. A length of the carbon nanotube may refer to a size of the carbon nanotube in a major axis. The average length may refer to an average of the lengths measured in a carbon nanotube powder.

In an embodiment, an average diameter of the carbon nanotube may be in a range from about 1 nm to about 20 nm, from about 1 nm to about 15 nm, from about 2 nm to about 15 nm, or from about 5 nm to about 15 nm. The diameter of the carbon nanotube may be a length in a minor axis perpendicular to the major axis of the carbon nanotube. The average diameter may refer to an average of the diameters measured in the carbon nanotube powder.

In the ranges of the length and diameter, dispersibility and electrical conductivity of the carbon nanotube may be further improved, and the internal resistance of the electrode for a lithium secondary battery may be lowered.

In example embodiments, a content of the carbon nanotube may be in a range from about 3 weight percent (wt %) to about 10 wt % based on a total weight of the conductive material dispersion. For example, if the content of the carbon nanotube is greater than 10 wt %, dispersibility may be reduced and a viscosity of the conductive material dispersion may be increased. For example, if the content of the carbon nanotubes is less than 3 wt %, electrical conductivity may be reduced and the internal resistance of the electrode may be increased.

In an embodiment, the content of the carbon nanotube may be in a range from about 3 wt % to about 9 wt %, from about 4 wt % to about 9 wt %, or from about 4 wt % to about 8 wt % based on the total weight of the conductive material dispersion.

In example embodiments, the dispersant may include a hydrogenated nitrile-based copolymer and a multivalent amine-based compound.

For example, the dispersant may include a first dispersant including the hydrogenated nitrile-based copolymer and a second dispersant including the multivalent amine-based compound.

The hydrogenated nitrile-based copolymer may include a α, β-unsaturated nitrile-derived unit, a hydrogenated conjugated diene-derived units and/or a conjugated diene-derived unit. For example, the hydrogenated nitrile-based copolymer may be formed by hydrogenating all or a portion of conjugated diene structural units of the nitrile-based copolymer.

The carbon nanotube may have a high specific surface area and a large aspect ratio, and may have strong cohesion due to a bonding energy of a surface and a strong van der Waals attraction. The carbon nanotube may be present in a solvent as aggregations due to a strong cohesive force, and the viscosity of the conductive material dispersion may be increased due to a low dispersibility of the carbon nanotube.

However, according to example embodiments, the conductive material dispersion includes the hydrogenated nitrile-based copolymer, and the dispersibility of carbon nanotube in the conductive material dispersion may be improved.

For example, the hydrogenated nitrile-based copolymer may form a hydrophobic interaction with respect to the carbon nanotube. Accordingly, the hydrogenated nitrile-based copolymer may be adsorbed on a surface of the carbon nanotube, thereby reducing the cohesiveness of the carbon nanotube.

In some embodiments, the hydrogenated nitrile-based copolymer may include a hydrogenated nitrile butadiene rubber (HNBR). The hydrogenated nitrile butadiene rubber has a relatively high affinity for the carbon nanotube, and thus an interaction between the conductive material and the dispersant may be further increased.

In example embodiments, a content of the hydrogenated nitrile-based copolymer may be in a range from about 10 parts by weight to about 100 parts by weight based on 100 parts by weight of the conductive material. Within the above range, dispersibility of the conductive material may be further improved, and energy density and electronic conductivity of the electrode may be enhanced.

In an embodiment, the content of the hydrogenated nitrile-based copolymer may be in a range from about parts by weight 10 to 50 parts by weight, or from about 10 parts by weight to 30 parts by weight, based on 100 parts by weight of the conductive material.

In an embodiment, a weight average molecular weight (Mw) of the hydrogenated nitrile-based copolymer may be in a range of 10,000 Da to 300,000 Da, from 50,000 Da to 200,000 Da, or from 100,000 Da to 150,000 Da. In the above range, dispersibility of the conductive material may be further improved, and the viscosity of the conductive material dispersion may be appropriately adjusted. For example, the weight average molecular weight may be calculated with respect to polystyrene based on a measurement result by a gel permeation chromatograph (GPC).

In an embodiment, a content of a nitrile-derived unit in the hydrogenated nitrile-based copolymer may be in a range from about 15 wt % to about 45 wt %, from about 15 wt % to about 35 wt %, or from about 25 wt % to about 35 wt % based on a total weight of the hydrogenated nitrile-based copolymer. In the above range, the interaction between the hydrogenated nitrile-based copolymer and the conductive material may be further increased, and dispersibility of the conductive material may be further improved.

The multivalent amine-based compound may refer to a compound having two or more amine functional groups in a molecular structure. For example, the amine functional group may include a monovalent amine group (NH₂) or a divalent amine group (NH).

In example embodiments, dispersibility of the carbon nanotube may be further increased by the multivalent amine-based compound in the conductive material dispersion.

For example, the carbon nanotube may have an oxidized portion on the surface thereof, e.g., a polar functional group such as a carboxyl group or a ketone group. The multivalent amine-based compound may include at least two amine functional groups, and thus an acid-base reaction may be performed with the polar functional group of the carbon nanotube. Accordingly, the multivalent amine-based compound may be further adsorbed on the carbon nanotube, and thus the cohesiveness of the carbon nanotube may be further reduced.

Further, the multivalent amine-based compound may form a hydrogen bond with the dispersion medium, e.g., a polar organic solvent, thereby increasing an affinity between the dispersion medium and the carbon nanotube. Thus, even though the carbon nanotube is included in the conductive material dispersion in a high content, dispersibility of the carbon nanotube may be further increased by the multivalent amine-based compound.

In example embodiments, the conductive material dispersion may have an amine value in a range from about 5 mgKOH/g to about 30 mgKOH/g.

In the above range, the acid-base reaction between the multivalent amine-based compound and the carbon nanotube may be promoted while maintaining high stability of the conductive material dispersion. For example, if the amine value of the conductive material dispersion is less than 5 mgKOH/g or more than 30 mgKOH/g, a sheet resistance of the conductive material dispersion may be increased, and storage stability may be degraded.

In an embodiment, the amine value of the conductive material dispersion may be about in a range from 6 mgKOH/g to about 28 mgKOH/g, from about 6 mgKOH/g to about 25 mgKOH/g, or from about 10 mgKOH/g to about 25 mgKOH/g.

In some embodiments, the multivalent amine-based compound may include at least one of compounds represented by Chemical Formulae 1 to 3.

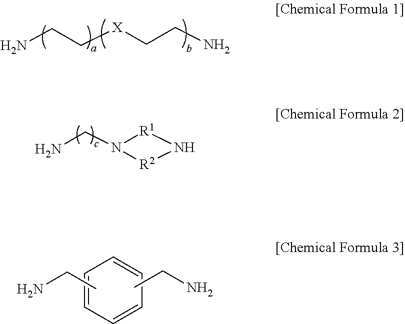

In Chemical Formula 1, X may be —O—, —NH—, or —N(CH₂CH₂NH₂)—, 1≤a≤10 and 0≤b≤10. In an embodiment, in Chemical Formula 1, 1≤a≤3 and 0≤b≤4.

In Chemical Formula 2, R¹ and R² may each independently be a C1 to C10 alkylene group, and 1≤c≤3. The alkylene group may mean a divalent hydrocarbon group from which two hydrogen atoms are separated from a linear or branched hydrocarbon group.

In an embodiment, in Chemical Formula 3, alkylamine groups may be bonded to ortho, meta or para positions of a benzene ring.

The compounds represented by Chemical Formulae 1 to 3 have high acid-base reactivity to the carbon nanotube, thereby further increasing adsorption properties of the dispersant with respect to the conductive material.

In an embodiment, b in Formula 1 may be 1 or more. For example, 1≤b≤4 in Formula 1. The multivalent amine-based compound may include a structural unit designated as b in Chemical Formula 1, so that the reactivity between the multivalent amine-based compound and carbon nanotube may be further increased.

In an embodiment, in Chemical Formula 2, R¹ and R² may each independently be a C1 to C5 alkylene group or a C1 to C3 alkylene group. In Chemical Formula 2, 1≤c≤2.

In some embodiments, the multivalent amine-based compound may include a compound represented by Chemical Formula 1 and/or Chemical Formula 2. Thus, the multivalent amine-based compound may have an aliphatic or alicyclic structure, so that the interaction with the carbon nanotubes and dispersibility of the conductive material dispersion may be further improved.

In an embodiment, the multivalent amine-based compound may include at least one of compounds represented by Chemical Formulae 4 to 11.

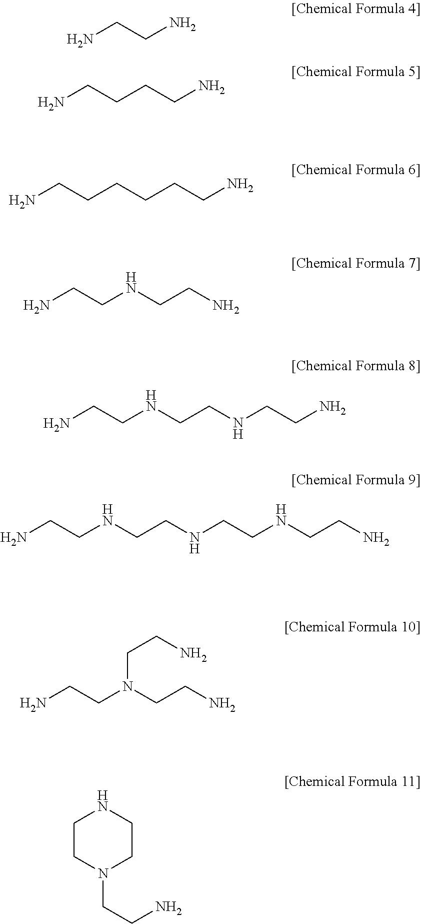

In example embodiments, a content of the multivalent amine-based compound may be in a range from about 5 parts by weight to about 50 parts by weight based on 100 parts by weight of the conductive material. In the above range, dispersibility of the conductive material may be further improved, and energy density and electronic conductivity of the electrode may be enhanced.

In an embodiment, the content of the multivalent amine-based compound may be in a range from about 10 parts by weight to about 40 parts by weight, or from about 10 parts by weight to about 30 parts by weight, based on 100 parts by weight of the conductive material.

In some embodiments, a weight ratio of the multivalent amine-based compound relative to the hydrogenated nitrile-based copolymer may be in a range from about 0.5 to about 2. In the above range, electrical conductivity and energy density of the electrode may be further improved while further preventing aggregation of the conductive material and lowering the viscosity of the conductive material dispersion.

In an embodiment, the weight ratio of the content of the multivalent amine-based compound relative to the hydrogenated nitrile-based copolymer may be in a range from about 0.5 to about 1.5, from about 0.7 to about 1.3, or from about 0.8 to about 1.2.

In example embodiments, the conductive material dispersion may include a solvent. For example, the solvent may include an aqueous solvent or a non-aqueous solvent.

In an embodiment, the solvent may include the non-aqueous solvent. The solvent may include a polar organic solvent to have enhanced compatibility with an electrode slurry.

In an embodiment, the polar organic solvent may include an alcohol-based solvent such as methanol, ethanol, 1-propanol, 2-propanol, n-butanol, iso-butanol, sec-butanol, tert-butanol, pentanol, hexanol, etc.; a ketone-based solvent such as methyl ethyl ketone; an ester-based solvent such as methyl acetate; an amine-based solvent such as N,N-dimethylaminopropylamine, diethyl triamine, etc.; an amide-based solvent such as dimethylformamide, diethylformamide, dimethylacetamide (DMAc), N-methyl-2-pyrrolidone (NMP), etc.

In one embodiment, the polar organic solvent may include the amide-based solvent, and may include, e.g., N-methyl-2-pyrrolidone (NMP). In this case, miscibility in the electrode slurry may be further improved.

Even though the conductive material dispersion contains the polar organic solvent, dispersibility of the conductive material dispersion may be enhanced by using the dispersant and the amine value range.

In some embodiments, when a UV absorbance (AU) of the conductive material dispersion is measured under a concentration condition of 10 mg/L to 100 mg/L, the UV absorbance measured in a wavelength range of 300 nm to 500 nm may be 0.5 or more. For example, the conductive material dispersion is diluted with a dilution solvent to prepare a diluted solution of 10 mg/L to 100 mg/L, and the UV absorbance (AU) of the diluted solution may be measured. As the dilution solvent, the same solvent as those included in the conductive material dispersion may be used.

The absorbance may be calculated by a Beer-Lambert law and may have a dimensionless unit. The diluted solution may be prepared by adding the non-aqueous solvent included in the conductive material dispersion to the conductive material dispersion in an amount of 1,000 to 2,000 times a volume of the conductive material dispersion.

In the case of using the multi-walled carbon nanotubes that may be individually dispersed due to a π-plasmon resonance absorption phenomenon on the surface of the carbon nanotube (CNT), the absorbance may appear in a wavelength range of 300 nm to 500 nm. However, in the CNT aggregate, the absorbance may not appear in the wavelength range of 300 nm to 500 nm, or the absorbance may become relatively low. Thus, as the absorbance of the conductive material dispersion becomes greater, dispersibility of the carbon nanotube may be increased.

In an embodiment, the UV absorbance of the diluted solution measured in the wavelength range of 300 nm to 500 nm may be 1.0 or less, or 0.9 or less.

In an embodiment, the UV absorbance of the diluted solution measured in the wavelength range of 300 nm to 400 nm may be 0.55 or more. In an embodiment, the UV absorbance of the diluted solution measured in the wavelength range of 300 nm to 350 nm may be 0.6 or more.

In the above ranges, the conductive material dispersion may have high dispersibility, and the viscosity of the conductive material dispersion may be controlled to an appropriate range.

In example embodiments, the conductive material dispersion may be prepared by mixing the conductive material, the hydrogenated nitrile-based copolymer, the multivalent amine-based compound and the solvent. For example, the mixture may be prepared by adding the conductive material, the hydrogenated nitrile-based copolymer, and the multivalent amine-based compound to the solvent, and then performing a rotation, a vibration, a sliding, a rolling, a lifting or an ultrasonic treatment.

In an embodiment, a dispersing process for the mixture may be additionally performed. For example, the conductive material, the hydrogenated nitrile-based copolymer and the multivalent amine-based compound may be uniformly mixed and dispersed in the solvent using a mixer, a disperser, a high pressure disperser, a nano high pressure disperser, an ultrasonic disperser, etc.

In an embodiment, the mixing and dispersing may be performed together. For example, the conductive material, the dispersant and the solvent may be mixed through the above-described dispersing process, so that the conductive material and the dispersant may be uniformly dispersed in the solvent.

An electrode slurry according to embodiments of the present disclosure may include the above-described conductive material dispersion. For example, the electrode slurry may include an electrode active material and the conductive material dispersion.

For example, a preliminary electrode slurry may be prepared by mixing and stirring the electrode active material in a solvent, and the above-described conductive material dispersion may be added. For example, the electrode slurry may be prepared by introducing and mixing the electrode active material into the conductive material dispersion.

The electrode active material may be a cathode active material or an anode active material.

Examples of the cathode active material may include at least one compound selected from a lithium iron phosphate-based compound, a lithium cobalt-based oxide, a lithium manganese-based oxide, a lithium nickel-based oxide, a lithium composite oxide, etc.

In an embodiment, the cathode active material may be a layered compound such as lithium cobalt oxide (LiCoO₂) or lithium nickel oxide (LiNiO₂), or a lithium manganese oxide such as LiMnO₃, LiMn₂O₃ and LiMnO₂, a lithium copper oxide (Li₂CuO₂), a vanadium oxide such as LiV₃O₈, V₂O₅ and Cu₂VO₇, a lithium iron phosphate oxide such as LiFePO₄, etc.

In some embodiments, the cathode active material may include a compound represented by Chemical Formula 12 below.

LiₐNi_{b}M_{1-b}O₂ [Chemical Formula 12]

In Chemical Formula 12, 0.95≤a≤1.08, b≥0.5, and M may include at least one element from Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Sr.

In an embodiment, the cathode active material may include nickel (Ni), and may further include at least one of cobalt (Co) and manganese (Mn). For example, a nickel-cobalt-manganese (NCM)-based lithium oxide may be used as the cathode active material.

For example, nickel (Ni) may be provided as a metal related to the capacity of a lithium secondary battery. As a nickel content becomes greater, the capacity and power of the lithium secondary battery may be increased. However, if the nickel content is excessively increased, life-span properties may be degraded and mechanical and electrical stability may also be lowered.

In an embodiment, a conductivity or a resistance of the lithium secondary battery may be improved by cobalt (Co), and mechanical and electrical stability of the lithium secondary battery may be improved by manganese (Mn).

The chemical structure represented by Chemical Formula 1 indicates a bonding relationship included in a layered structure or a crystal structure of the cathode active material, and is not intended to exclude another additional element. For example, M may serve as main active elements of the cathode active material. Chemical Formula 12 is provided to express the bonding relationship of the main active elements, and is to be understood as a formula encompassing introduction and substitution of the additional element.

In an embodiment, an auxiliary element for enhancing chemical stability of the cathode active material or the layered structure/crystal structure may be further included in addition to the main active element. The auxiliary element may be incorporated into the crystal structure to form a bond, and it is to be understood that this case is also included within the chemical structure represented by Chemical Formula 12.

The anode active material may include material widely known in the related art capable of intercalating and de-intercalating lithium ions without a particular limitation. For example, a carbon-based material such as a crystalline carbon, an amorphous carbon, a carbon composite, a carbon fiber, etc.; a lithium alloy; silicon or tin may be used.

Examples of the amorphous carbon may include hard carbon, coke, a mesocarbon microbead (MCMB) fired at 1500° C. or less, a mesophase pitch-based carbon fiber (MPCF), etc. Examples of the crystalline carbon may include a graphite-based carbon such as an artificial graphite, a natural graphite, a graphitized coke, a graphitized MCMB, a graphitized MPCF, etc. Examples of elements included in the lithium alloy may include aluminum, zinc, bismuth, cadmium, antimony, silicon, lead, tin, gallium, indium, etc.

In an embodiment, the electrode slurry may further include a binder.

The binder may include an aqueous binder such as styrene-butadiene rubber (SBR), vinylidene fluoride-hexafluoropropylene copolymer (PVDF-co-HFP), polyvinylidene fluoride (PVDF), polyacrylonitrile, polymethyl methacrylate, nitrile butadiene rubber, etc.

In an embodiment, the electrode slurry may include the cathode active material, and the binder may include a PVDF-based binder. In an embodiment, the electrode slurry may include the anode active material, and the binder may include, e.g., an aqueous binder for a compatibility consistency with the carbon-based active material.

In an embodiment, the electrode slurry may further include a thickener such as carboxymethyl cellulose (CMC).

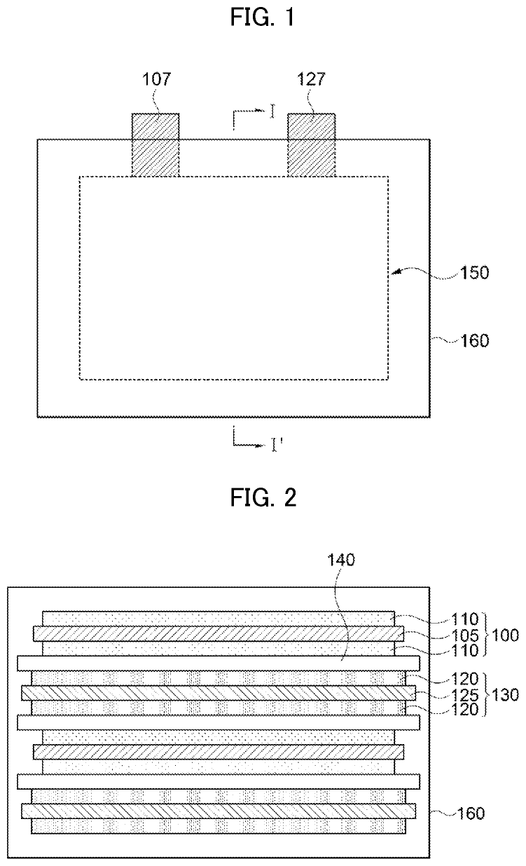

FIGS. 1 and 2 are a schematic plan view and a schematic cross-sectional view illustrating a secondary battery in accordance with exemplary embodiments.

Referring to FIGS. 1 and 2, the lithium secondary battery may include a cathode 100 and an anode 130 facing the cathode 100. At least one of the cathode 100 and the anode 130 may be an electrode for a lithium secondary battery formed of the electrode slurry described above.

The cathode 100 may include a cathode current collector 105 and a cathode active material layer 110 formed on at least one surface of the cathode current collector 105. For example, the cathode slurry may be coated on at least one surface of the cathode current collector 105, and then dried and pressed to prepare the cathode 100.

The cathode current collector 105 may include stainless steel, nickel, aluminum, titanium, or an alloy thereof. The cathode current collector 105 may include carbon, nickel, titanium, or aluminum or stainless steel surface-treated with silver.

The anode 130 may include an anode current collector 125 and an anode active material layer 120 formed on at least one surface of the anode current collector 125.

The anode current collector 125 may include, e.g., gold, stainless steel, nickel, aluminum, titanium, copper, or an alloy thereof, and may include, e.g., copper or a copper alloy.

In an embodiment, the electrode for a lithium secondary battery may serve as the cathode, and a counter electrode may be an anode. In an embodiment, the electrode for a lithium secondary battery may serve as the anode, and the counter may be the cathode.

In an embodiment, the counter electrode may include a carbon-based conductive material such as graphite, carbon black, graphene, a carbon nanotube, etc.; and/or a metal-based conductive material including tin, tin oxide, titanium oxide, a perovskite material such as LaSrCoO₃, LaSrMnO₃, etc., as a conductive material.

In some embodiments, a separator 140 may be interposed between the cathode 100 and the anode 130. The separator 140 may include a porous polymer film formed of a polyolefin-based polymer such as an ethylene homopolymer, a propylene homopolymer, an ethylene/butene copolymer, an ethylene/hexene copolymer, an ethylene/methacrylate copolymer, etc. The separator 140 may include a non-woven fabric formed of a glass fiber having a high melting point, a polyethylene terephthalate fiber, etc.

In example embodiments, the cathode 100, the anode 130 and the separator 140 may be repeatedly disposed to form an electrode assembly 150. In some embodiments, the electrode assembly 150 may have a winding-type shape, a stacked shape, a z-zag folding shape, a stack-folding shape.

A lithium secondary battery may be defined by accommodating the electrode assembly 150 in a case 160. The lithium secondary battery may be manufactured in, e.g., a cylindrical shape using a can, a prismatic shape, a pouch shape, or a coin shape.

Electrode tabs (a cathode tab and an anode tab) may protrude from each cathode current collector 105 and each anode current collector 125 to extend to one side of the case 160. The electrode tabs may be fused together with the one side of the case 160 to form electrode leads (a cathode lead 107 and an anode lead 127) extending or exposed to an outside of the case 160.

In example embodiments, an electrolyte solution may be accommodated in the case 160 together with the electrode assembly 150. A non-aqueous electrolyte solution may be used as the electrolyte.

The non-aqueous electrolyte solution may include a lithium salt as an electrolyte and an organic solvent. The lithium salt may be represented by Li⁺X. Examples of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃—, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulfolane, gamma-butyrolactone, propylene sulfite, tetrahydrofuran, etc. These may be used alone or in a combination thereof.

Hereinafter, experimental examples are proposed to more concretely describe embodiments in the present disclosure. However, the following examples are only given for illustrating the present disclosure and those skilled in the related art will obviously understand that various alterations and modifications are possible within the scope and spirit of the present disclosure. Such alterations and modifications are duly included in the appended claims.

### Preparation Example: Conductive Material Dispersion

### (1) Example 1

In an NMP (N-methylpyrrolidone) solvent, 2.25 g of carbon nanotubes (MWCNT, length: 100 μm to 200 μm, outer diameter: 10 nm to 15 nm), a hydrogenated nitrile butadiene rubber (HNBR, MW: 130,000 Da) and a multivalent amine-based compound were mixed in a content (g) of Table 1 below to prepare a mixed solution of 50 g (solid content).

The mixed solution was mixed at a rate of 2,000 rpm for 60 minutes using a mixer (ARE-310, Thinky Corp.) to prepare a conductive material dispersion.

### (1) Examples 2 to 11 and Comparative Examples

Conductive material dispersions were prepared by the same method as that in Example 1, except that types and contents of the dispersants were changed as shown in Table 1 below.

TABLE 1

| | | multivalent amine-based | | | |
|---|---|---|---|---|---|
| | HNBR | compound | | additive | |
| | content | type | content | type | content |
| Example 1 | 0.45 | A-1 | 0.225 | — | — |
| Example 2 | 0.45 | A-1 | 0.45 | — | — |
| Example 3 | 0.45 | A-1 | 0.675 | — | — |
| Example 4 | 0.45 | A-1 | 0.9 | — | — |
| Example 5 | 0.45 | A-2 | 0.45 | — | — |
| Example 6 | 0.45 | A-3 | 0.45 | — | — |
| Example 7 | 0.45 | A-4 | 0.45 | — | — |
| Example 8 | 0.45 | A-5 | 0.45 | — | — |
| Example 9 | 0.45 | A-6 | 0.45 | — | — |
| Example 10 | 0.45 | A-7 | 0.45 | — | — |
| Example 11 | 0.45 | A-8 | 0.45 | — | — |
| Comparative | 0.45 | — | — | — | — |
| Example 1 | | | | | |
| Comparative | 0.45 | A-1 | 0.113 | — | — |
| Example 2 | | | | | |
| Comparative | 0.45 | A-1 | 1.125 | — | — |
| Example 3 | | | | | |
| Comparative | 0.45 | — | — | B-1 | 0.225 |
| Example 4 | | | | | |
| Comparative | 0.45 | — | — | B-2 | 0.225 |
| Example 5 | | | | | |
| Comparative | 0.45 | — | — | B-3 | 0.225 |
| Example 6 | | | | | |

The specific compounds in Table 1 are as follows.
A-1: a compound represented by Chemical Formula 4
A-2: a compound represented by Chemical Formula 5
A-3: a compound represented by Chemical Formula 6
A-4: a compound represented by Chemical Formula 7
A-5: a compound represented by Chemical Formula 8
A-6: a compound represented by Chemical Formula 9
A-7: a compound represented by Chemical Formula 10
A-8: a compound represented by Chemical Formula 11
B-1: NaOH
B-2: aminoethanol
B-3: benzylamine

### Experimental Example

### (1) Measurement of Amine Value

2 g of the conductive material dispersion prepared in each of Examples and Comparative Examples was quantified and added to a container, and 40 g of water was added thereto. An aqueous solution containing the conductive material dispersion was mixed using a mixer (ARE-310, Thinky Corp.). After the filtration, a filtrate was obtained and the filtrate was titrated with a potential difference titer (Mettler Toledo, Inc., Excellence T50, DGi115-SC electrode, titanium 0.1 M HCl aqueous solution). An amine value (per gram) of the conductive material dispersion was measured from a titrant volume at a final equivalent point and a content of the multivalent amine-based material contained in 2 g of the conductive material dispersion.

### (2) Evaluation on Surface Resistance

98.2 parts by weight of a cathode active material (LiNi_{0.88}Co_{0.1}Mn_{0.02}O₂) and 1.2 parts by weight of a binder (8% by mass of PVDF) were added to an NMP (N-methyl-2-pyrrolidone) solvent. Mixing was performed at 1,000 rpm for 10 minutes using a mixer (ARE-310, Thinky Corp.). 0.6 parts by weight of the conductive material dispersion prepared in each of Examples and Comparative Examples was added to the slurry including the cathode active material and the binder. Thereafter, mixing was performed at 1,000 rpm for 10 minutes using a mixer to obtain a cathode active material slurry. A total solid content of the cathode active material slurry was 60 wt % to 70 wt %.

The cathode active material slurry was coated on a PET substrate (thickness: 50 μm) using an applicator. The slurry was dried using an electric oven at 70° C. for 1 hour and at 110° C. for 2 hours to obtain a cathode film for measuring a sheet resistance having an average thickness of 95 μm to 100 μm (excluding a thickness of the PET substrate).

Sheet resistances were measured at 6 points of the cathode film using an equipment (Nitto Seiko Analytech, LORESTA-GX, MCP-T700), and an average value was obtained.

### (3) Evaluation on Storage Stability.

Storage stability was evaluated by calculating a change of a UV absorption intensity during a storage period of the conductive material dispersion prepared in Examples and Comparative Examples. Specifically, a dispersing property was determined from the UV absorption intensity of the carbon nanotubes (CNTs) dispersed in the conductive material dispersion or dispersed CNT aggregates.

In the case of individually dispersed multi-walled CNTs, the absorbance is shown in a wavelength range of 300 nm to 500 nm. In the case of the CNT aggregates, the absorbance does not appear in a wavelength range of 300 nm to 500 nm, or the absorbance is relatively low. Thus, dispersibility was confirmed and measured using the UV absorption intensity of the conductive material dispersion.

The initial UV absorption intensity of the conductive material dispersion prepared in each of Examples and Comparative Examples was measured within 3 days after the preparation. Specifically, the conductive material dispersion was diluted 1,000 to 2,000 times using NMP. The UV absorption intensity in the wavelength range of 300 nm to 500 nm was measured using a UV-VIS measurement equipment (Agilent, 8453 UV-Visible Spectrophotometer) with respect to the diluted solution of the conductive material dispersion.

The conductive material dispersion prepared in each of Examples and Comparative Examples was stored at room temperature for 4 weeks, and then the UV absorption intensity was measured by the same manner as that of the initial UV absorption intensity measurement. Storage stability was evaluated by calculating a change (a change ratio of the UV absorption intensity) of the UV absorption intensity measured after 4 weeks of the storage relative to the initial UV absorption intensity.

The change ratio of the UV absorption intensity was calculated as Equation 1 below.

UV absorption intensity change ratio (%)=(initial UV absorption intensity−UV absorption intensity after 4 weeks of storage)/initial UV absorption intensity×100 [Equation 1]

In Equation 1, the UV absorption intensity was based on the absorption intensity at a wavelength of 350 nm.

Criteria for evaluating storage stability are as follows.
⊚: UV absorption intensity change ratio was 5% or less
∘: UV absorption intensity change ratio was greater than 5% and 10% or less
Δ: UV absorption intensity change ratio was greater than 10% and 20% or less
X: UV absorption intensity change ratio exceeded 20%

The evaluation results are shown in Table 2 below.

TABLE 2

| | amine value | sheet resistance | storage |
|---|---|---|---|
| | (mgKOH/g) | (Ω/□) | stability |
| Example 1 | 6.58 | 2855 | ◯ |
| Example 2 | 13.72 | 2742 | ⊚ |
| Example 3 | 20.49 | 2564 | ⊚ |
| Example 4 | 28.71 | 2933 | ◯ |
| Example 5 | 5.71 | 3112 | Δ |
| Example 6 | 5.01 | 3320 | Δ |
| Example 7 | 8.02 | 2895 | ◯ |
| Example 8 | 7.56 | 2285 | ⊚ |
| Example 9 | 5.92 | 2711 | ⊚ |
| Example 10 | 8.48 | 2170 | ⊚ |
| Example 11 | 6.30 | 2302 | ⊚ |
| Comparative | 0 | 5518 | X |
| Example 1 | | | |
| Comparative | 1.99 | 4217 | Δ |
| Example 2 | | | |
| Comparative | 33.87 | 3195 | Δ |
| Example 3 | | | |
| Comparative | 0.25 | 2578 | X |
| Example 4 | | | |
| Comparative | 2.76 | 2961 | Δ |
| Example 5 | | | |
| Comparative | 1.03 | 4811 | X |
| Example 6 | | | |

Referring to Table 1 and Table 2, the conductive material dispersion of Embodiments had an amine value of 5 mgKOH/g to 30 mgKOH/g. In Examples, the conductive material dispersion had a low sheet resistance, and storage stability was improved.

The conductive material dispersion in Comparative Examples had an amine value less than 5 mgKOH/g or greater than 30 mgKOH/g. In Comparative Examples, the conductive material dispersion had a high sheet resistance, or storage stability was deteriorated.

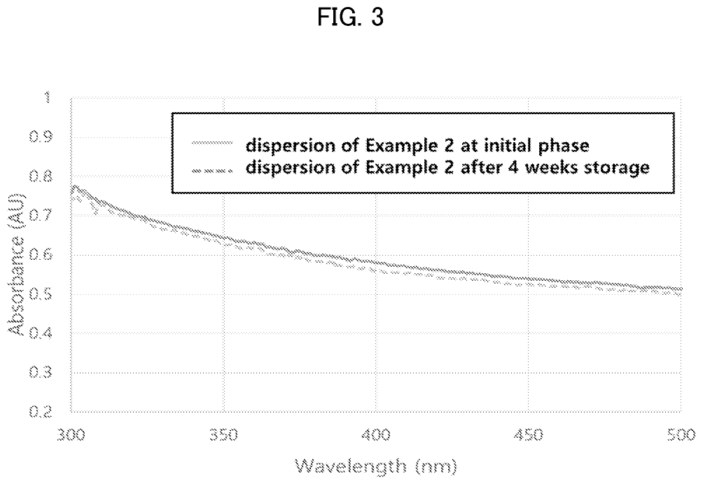

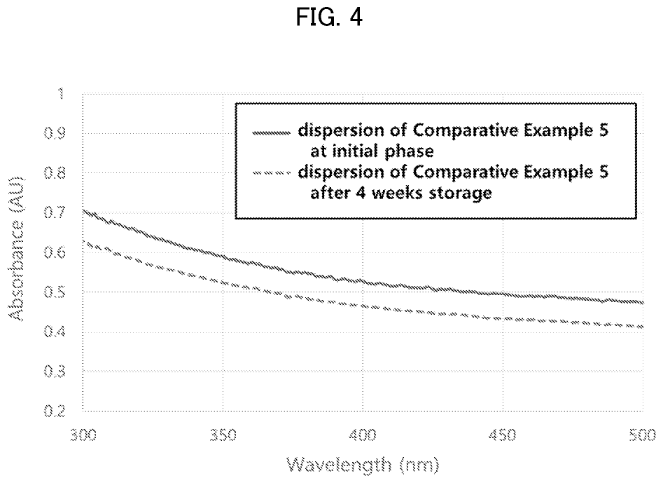

FIG. 3 is a graph showing an absorbance of a conductive material dispersion prepared in Example 2. FIG. 4 is a graph showing an absorbance of a conductive material dispersion prepared in Comparative Example 5.

Referring to FIG. 3, the conductive material dispersion prepared in Example 2 had a small UV absorption intensity change ratio in the wavelength range of 300 nm to 500 nm, and the CNTs were not aggregated and dispersed even after a long period. The conductive material dispersion prepared in Example 2 had improved storage stability.

Referring to FIG. 4, the conductive material dispersion prepared in Comparative Example 5 had a relatively large reduction of the UV absorption intensity in the wavelength range of 300 nm to 500 nm, and the CNTs were aggregated with each other in the conductive material dispersion as the storage period increased.

What is claimed is:

1. A conductive material dispersion, comprising:
a conductive material including carbon nanotubes;
a hydrogenated nitrile-based copolymer;
a multivalent amine-based compound; and
a solvent,
wherein an amine value of the conductive material dispersion is in 5 mgKOH/g to 30 mgKOH/g.

2. The conductive material dispersion according to claim 1, wherein a content of the conductive material is 3 wt % to 10 wt % based on a total weight of the conductive material dispersion.

3. The conductive material dispersion according to claim 1, wherein a content of the hydrogenated nitrile-based copolymer is 10 parts by weight to 50 parts by weight based on 100 parts by weight of the conductive material.

4. The conductive material dispersion according to claim 1, wherein a content of the multivalent amine-based compound is 5 parts by weight to 50 parts by weight based on 100 parts by weight of the conductive material.

5. The conductive material dispersion according to claim 1, wherein a weight ratio of the multivalent amine-based compound relative to the hydrogenated nitrile-based copolymer is 0.5 to 2.

6. The conductive material dispersion according to claim 1, wherein the hydrogenated nitrile-based copolymer comprises a hydrogenated nitrile butadiene rubber.

7. The conductive material dispersion according to claim 1, wherein the multivalent amine-based compound has at least two amine groups selected from the group consisting of a primary amine group (NH₂) and a secondary amine group (NH).

8. The conductive material dispersion according to claim 1, wherein the multivalent amine compound comprises at least one selected from the group consisting of Chemical Formulae 1 to 3: 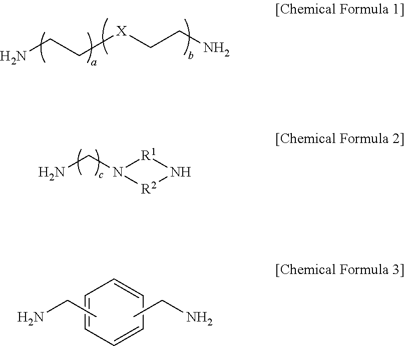
wherein, in Chemical Formula 1, X represents —O—, —NH— or —N(CH₂CH₂NH₂)—, 1≤a≤10 and 0≤b≤10, and
wherein, in Chemical Formula 2, R¹ and R² are each independently a C1 to C10 alkylene group, and 1≤c≤3.

9. The conductive material dispersion according to claim 8, wherein 1≤a≤3 and 0≤b≤4 in Chemical Formula 1.

10. The conductive material dispersion according to claim 1, wherein the solvent comprises a non-aqueous solvent.

11. The conductive material dispersion according to claim 10, wherein the non-aqueous solvent comprises a polar organic solvent.

12. The conductive material dispersion according to claim 1, wherein a UV absorbance (AU) in a wavelength range of 300 nm to 500 nm is 0.5 or more when the UV absorbance of the conductive material dispersion is measured under a concentration condition of 10 mg/L to 100 mg/L.

13. An electrode slurry comprising:
the conductive material dispersion according to claim 1;
an electrode active material; and
a binder.

14. The electrode slurry according to claim 13, wherein the electrode active material is a cathode active material.

15. A lithium secondary battery, comprising:
an electrode for a lithium secondary battery comprising an electrode active material layer formed from the electrode slurry according to claim 13; and
a counter electrode facing the electrode for a lithium secondary battery.
